(19) United States
(12) Patent Application Publication
(10) Pub. No.: US 2015/0247912 A1
(43) Pub. Date: Sep. 3, 2015

(54) CAMERA CONTROL FOR FAST AUTOMATIC OBJECT TARGETING

(71) Applicants: Xueming Tang, Canton, MI (US); Hai Yu, Canton, MI (US)

(72) Inventors: Xueming Tang, Canton, MI (US); Hai Yu, Canton, MI (US)

(21) Appl. No.: 14/194,764

(22) Filed: Mar. 2, 2014

(51) Int. Cl. G01S 3/786

(52) U.S. Cl. CPC G01S 3/7864

(57) ABSTRACT

A camera controller is configured to automatically target object in camera view based on determined object position in a field coordinate system. The object position is initially determined based on received radio wave signals from object associated wireless communication device in a wireless local area network. The camera controller targets the object in camera view according to the determined object position using at least one of the camera orientation adjustment and the object recognition methods. The object position is further refined based on recognized object in camera view and the relationship between the camera view coordinate system and the local area coordinate system for better object targeting effect. The camera controller is able to capture an object in camera view even before the object has been specified as the target object.

### CROSS-REFERENCE TO RELATED APPLICATIONS

This application is a continuation of U.S. Provisional Patent Application Ser. No. 61/864,533

### TECHNICAL FIELD

Various embodiments relate to automatic object targeting for camera view control.

### BACKGROUND

Camera view control systems apply camera orientation adjustment and object recognition technologies to cover different area and to find a target object in camera view. Many prior art schemes work only when an object to be tracked is already in camera view and is recognized. Before that, users have to manually control the camera view device to scan a local area in order to find and specify an object of interest. There is no available method to automatically initialize the camera view to cover an object before it has been specified as the target object of interest. On the other hand, an object not appeared in camera view cannot be specified either.

While working in an activity area covered by a wireless local area network, the received radio wave signals from a wireless communication device associated to an object can be used to determine the position of the object in the activity area. Furthermore, when a field coordinate system is defined for the activity area, the object position can be uniquely represented in coordinates. Such identified object position can be used for a camera view control system to initially locate the object of interest in order to automatically target the object in camera view.

### SUMMARY OF THE INVENTION

The following summary provides an overview of various aspects of exemplary implementations of the invention. This summary is not intended to provide an exhaustive description of all of the important aspects of the invention, or to define the scope of the inventions. Rather, this summary is intended to serve as an introduction to the following description of illustrative embodiments.

In a first illustrative embodiment, a camera includes a view control device configured for automatic object targeting; and a controller configured to receive radio wave signals from wireless communication devices in a wireless local area network and determine the position of an object in a field coordinate system based on radio wave signals from a wireless communication device associated to the object such that the camera orientation adjustment and object recognition can be used by the view control device to target the object in camera view according to the determined object position.

In a second illustrative embodiment, a method includes determining the position of an object in a field coordinate system based on received radio wave signals from a wireless communication device associated to the object and performing the camera orientation adjustment and object recognition for the camera view control device to target the object in camera view automatically according to the determined object position.

In a third illustrative embodiment, a view control system includes at least one controller configured to determine the position of an object in a field coordinate system based on received radio wave signals from a wireless communication device associated to the object and to perform the camera orientation adjustment and object recognition for the camera view control device to target the object in camera view automatically according to the determined object position.

Additional features and advantages of the invention will be made apparent from the following detailed description of illustrative embodiments.

### BRIEF DESCRIPTION OF THE DRAWINGS

FIG. 1 is a schematic diagram of a camera and camera view control system that automatically target an object at a determined field position according to one or more embodiments;

FIG. 2 is a schematic diagram of a WLAN based local positioning system that can determine the position of radio frequency communication or positioning devices in an area covered by WLAN network according to one or more embodiments;

FIG. 3 is a flowchart illustrating a method of WLAN based object position determination according to one or more embodiments;

FIG. 4 is an illustration of a camera with camera view control device that physically adjust the camera orientation in a camera system coordinate system according to one or more embodiments;

FIG. 5 is an illustration of a camera system with camera view control device that digitally adjust the pan-tilt-zooming control to determine camera orientation and view in a camera frame coordinate system according to one or more embodiments;

FIG. 6 is a schematic diagram of camera orientation based positioning method that is used to determine the aim-point position of a camera system in the field coordinate system as well as to determine the camera orientation based on target aim-point position according to one or more embodiments;

FIG. 7 is a flowchart illustrating a method of camera orientation adjustment according to one or more embodiments;

FIG. 8 is a flowchart illustrating a method of vision based object positioning according to one or more embodiments;

FIG. 9 is a schematic diagram illustrating an object recognition method for object initialization and following in camera view frames according to one or more embodiments;

FIG. 10 is a flowchart illustrating a method of object recognition for object targeting in camera view according to one or more embodiments;

FIG. 11 is a flowchart illustrating a method for target aim-point's motion determination and desired camera orientation motion determination according to one or more embodiments.

FIG. 12 is a flowchart illustrating a method of camera view control for automatic object targeting according to one or more embodiments;

### DETAILED DESCRIPTION OF THE INVENTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The present invention discloses methods and apparatus for a new camera view control system that is able to capture and follow an object of interest in camera view even before the object has been specified as the target object. As a result, fast and automatic object initialization can be achieved for camera based object targeting and object following functions.

In this system, video frames are captured from a camera whose orientation is determined by the camera view control device's position and motion in a camera system coordinate system. The camera's orientation and zooming ratio determine the region of a field covered by the camera view frame. The camera orientation also determines the position in the field where the center of the captured frame is at.

Exemplary embodiment of the camera's view control device for orientation adjustment includes the camera platform's pan and tile angles as well as their angular speeds and angular accelerations. Alternative embodiment of the camera's orientation adjustment is realized by a software feature that allows the camera view delivered to the user by panning and tilting digitally a sub-frame within the full view of the camera frame without physically moving the camera. The sub-frame of the camera video is then delivered to service customer as the video output. The camera has control system that has computer software function to recognize candidate objects in camera frames.

When object targeting service is requested from users, even before a target object is specified for the camera, the camera view control system determine the position of an object of interest in a filed coordinate system defined for an activity field based on received radio wave signals from wireless communication devices associated to the object. The association of a wireless communication devices to an object mostly indicates that the devices is attached to the object, hold by the object or it is following the object closely such that the position of the device is regarded as the position of the object in the activity field. The camera view controller next perform at least one of orientation adjustment and object recognition for the camera view control device to target the object in camera view according to the determined position of the object in the activity field.

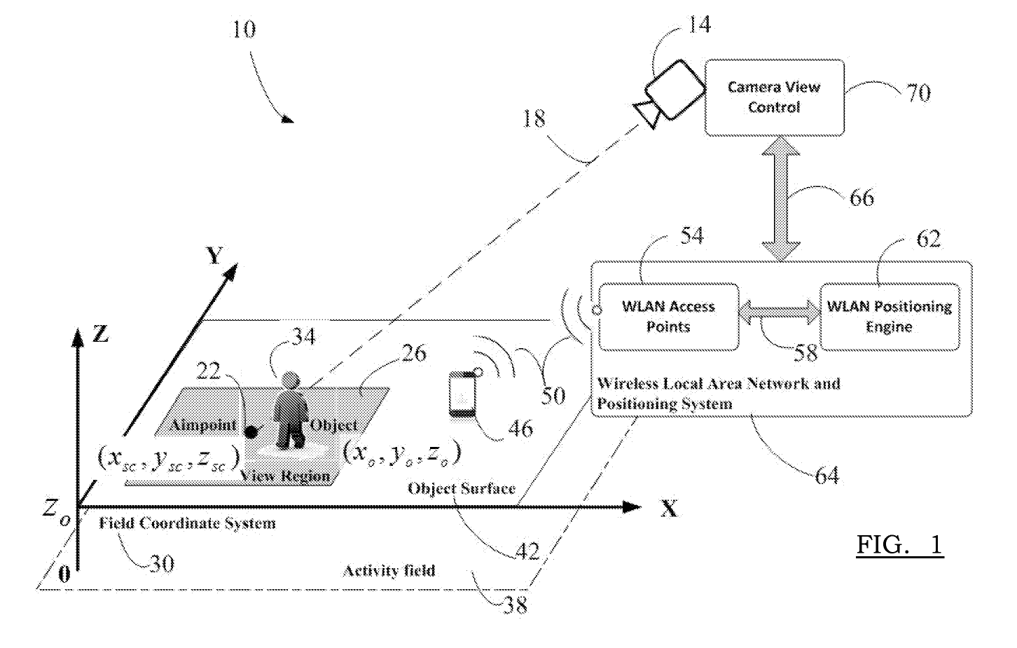

With reference to FIG. 1, a camera and camera view control system for providing service that automatically target an object in camera view is illustrated in accordance with one or more embodiments and is generally referenced by numeral 10. The view system 10 comprises a camera with view control device 14, a camera view control 70, a wireless local area network and positioning system 64, a field coordinate system 30 defined for an activity field 38.

A first novelty of the present invention is the incorporation of the field coordinate system (FCS) 30 and the positioning system 64 to the camera view service system 10. The field coordinate system 30 enables seamlessly integration of the positioning system 64 and the camera view control 70 to achieve unified and high precision object positioning and camera targeting functions. Exemplary embodiment of the field coordinate system is a two dimensional or three dimensional Cartesian coordinate system. In the two dimension case, two perpendicular lines are chosen and the coordinates of a point are taken to be the signed distances to the lines. In the three dimension (3D) case, three perpendicular planes are defined for the local activity region and the three coordinates of any location are the signed distances to each of the planes. In the present embodiment of the invention, the field coordinate system 30 is a 3D system with three planes, X-Y, X-Z and Y-Z, perpendicular to each other. A position in the field coordinate system 30 has unique coordinates (x, y, z) to identify where it is and its geographic and geometric relationships with respect to other position and object in the activity field.

In the field coordinate system 30, an object surface 42 at the height of zₒ defines the base activity plane for an object 34. The object 34 is illustrated as a human being in the activity field 38. The object surface 42 can be in any orientation angle with respect to the 3D planes of the field coordinate system. In the present embodiment, it is illustrated as a plane that is parallel to the X-Y plane. The camera line-of-sight 18 is the centerline of the camera lens and it determines the center point of the camera view. The intersection point of the line-of-sight 18 of the camera 14 with the object surface 42 defines the aim-point 22. The position of the object 34 in the field coordinate system is defined by (xₒ, yₒ, zₒ). The coordinates of aim-point 22 is (x_{sc}, y_{sc}, z_{sc}). On the object surface, the camera view region 26 is illustrated by a dark parallelogram. The view region 26 is the area on the activity field that is covered by the camera frames at the present camera orientation and zooming ratio. The aim-point 22 is at the center of the view region. Both the camera view frame and the view region 26 in the exemplary embodiments of the invention are rectangle in shape.

The position of the object 34 in the field coordinate system 30 is determined by the positioning system 64. In the primary embodiment of the invention, the positioning system is established based on a wireless local area network (WLAN). The WLAN and positioning system 64 comprises WLAN access points 54 and a WLAN positioning engine 62. The WLAN access points 54 receive radio wave signals 50 from a wireless communication device 46 in the activity field. Besides for normal communication functions, information from such signals as well as their reception properties are transmitted via communication channel 58 to the WLAN positioning engine 62 to determine the position of the wireless communication device 46 in the FCS 30. When the wireless communication device 46 is associated to the object 34, the determined position is also recognized as the position of the object 34 in the FCS 30. Subsequently, the determined position is communicated to the camera view control 70 via communication channel 66. Based on the determined object position in FCS 30, the camera view control 70 operates the camera view control device 14 to target the object in camera view using at least one of the following methods: 1) adjust camera orientation and zooming ratio such that the view region covers the object position with sufficient exhibition of the object in the camera view; 2) recognize and outline the object in the camera view presented to service users.

An embodiment of WLAN is a WiFi communication network. Typical wireless communication devices include WiFi tag device, smartphone and tablet computer, etc. From the WiFi devices, information data, operation commands and measurements are transmitted to the access points (APs) of the WiFi network. In an exemplary embodiment, these information and data will then be sent to a WLAN network station. Besides passing the normal network data, the WiFi network station redirect the received signal strength (RSS) data to the positioning engine 62, where the position of the WiFi device is determined based on fingerprinting data calibrated over the field coordinate system 30. Alternative embodiment of the wireless communication network can be a cellular network and an alternative embodiment of the positioning system can be a GPS.

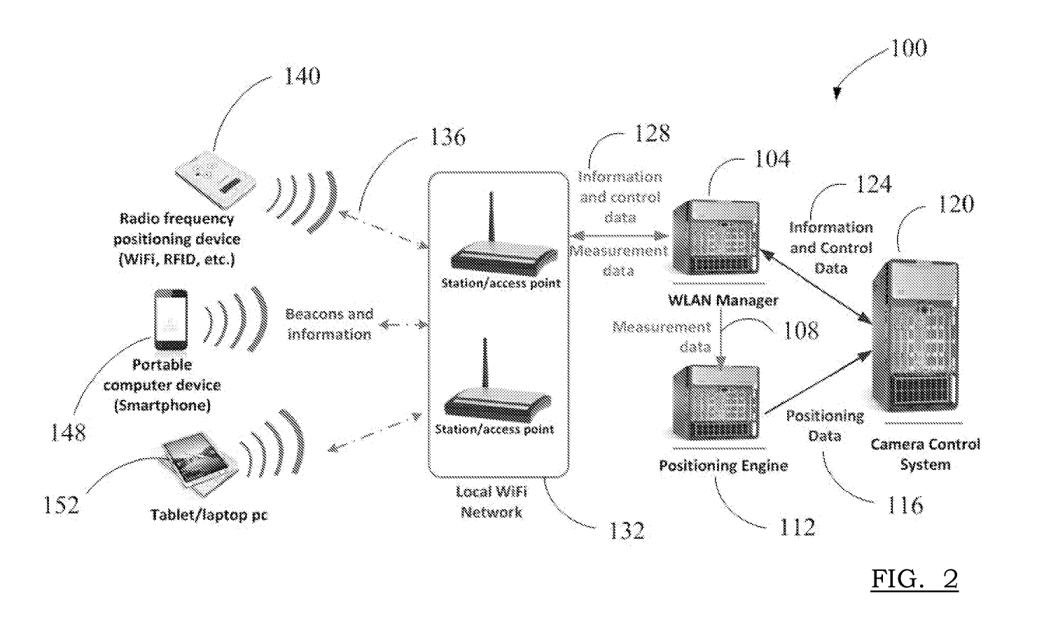

It is important to point out that the following descriptions of the technologies use target objects on a planar activity ground as an example to demonstrate the invention. This shall not be treated to limit the scale of the invention. The presented technology can be easily modified and extended to support applications in which the activities of the target object involves large vertical motions. With reference to FIG. 2, a WiFi based local positioning system is illustrated in accordance with one or more embodiments and is generally referenced by numeral 100. Such WiFi based local positioning system is used to determine the location of a target object in FCS 30 based on radio wave signal received from wireless communication device associated to the target object.

WiFi positioning has a distinct advantage of low cost and wireless connectivity. Through the local WiFi network, service users connect to the camera view system from wireless communication devices like smartphone 148, tablet/laptop computer 152, and WiFi attachment devices 140. Although WiFi has not been designed for positioning, its radio signal can be used for location estimation by exploiting the Received Signal Strength (RSS) value measured with respect to WiFi access points (APs). Alternatively, Angle of Arrival, Time of Arrival and Time Difference of Arrival can be used to determine the location based on geometry. The positioning methods used are at least one of pattern recognition method, triangulation method and trilateration method. The RSS based Fingerprinting method is a type of pattern recognition method for positioning and it is used as the exemplary embodiment to illustrate the new object targeting technology.

A typical local WiFi network 100 comprises WLAN stations and multiple access points 132. The distribution of the access points constructs a network topology that can be used for RSS fingerprinting based positioning service. Beacons and information messages 136 are communicated between the local WiFi network 132 and the wireless service terminal devices. The local WiFi network 132 communicates received information and measurement data 128 with a WLAN management unit called WLAN manager 104. The WLAN manager 104 then directs the positioning measurement data 108 to the positioning engine 112 while it direct service related information and control data 124 to the camera control system 120. The positioning engine 112 processes the received positioning measurement data 108 from the WLAN manager 104 to determine the present position and motion of the wireless communication devices in FCS 30. The determined position and motion data 116 is then sent to the camera control system 120 for object targeting functions.

For the camera viewing system, both network based WiFi positioning system topology and terminal assisted WiFi positioning system topology can be used. In the network based topology, the RSS measurement is done centralized by WiFi network stations 132 rather than by the wireless service terminal devices. Beacons 136 for positioning purpose are sent from the wireless communication devices 140, 148 and 152 and they are received by the stations in local WiFi network 132. The RSS measurement is carried out at the stations based on their received beacon signal strength. On the other hand, in the terminal assisted WiFi positioning system topology, signal beacons are generated at the network stations in the local WiFi network 132. The RSS measurement is carried out at individual wireless communication devices 140, 148 and 152. These devices then package the RSS measurement into positioning data messages and transmit the messages through the local WiFi network 132 to the WLAN manager 104. In both system topologies, the RSS measurement data is then redirected to the positioning engine 112. This engine has a location fingerprinting database that stores the RSS values that are obtained at different calibration points in the area of interest. In positioning application, a location estimation algorithm is used to estimate the present location based on the measured RSS values from a WiFi device at an unknown location and the previously created database of RSS map.

Location fingerprinting based WiFi positioning systems usually work in two phases: calibration phase and positioning phase. The following descriptions use the network based WiFi positioning system topology as an exemplary embodiment to introduce the fingerprinting based positioning method. In the calibration phase, a mobile device is used to send out wireless signal beacons at a number of chosen calibration points. The RSS values are measured from several APs. Each measurement becomes a part of the radio map and is a tuple (qᵢ, rᵢ), for i=1, 2, . . . , n known calibration locations. qᵢ=(xᵢ, yᵢ) are the coordinates of the i-th location in the field coordinate system. rᵢ=(rᵢ₁, rᵢ₂, . . . , rᵢₘ) are the m RSS values measured from APs with respect to signal beacons sent out at the calibration location. In the positioning phase, a mobile device sends out signal beacon at an unknown location. The RSS values are measures from the APs and the positioning engine estimate the location using the previously created radio map and a weighted k-Nearest Neighbors algorithm for location fingerprinting. After that, the (x, y) coordinate of the unknown location is determined. The fingerprinting techniques usually do not require knowing exact locations of APs.

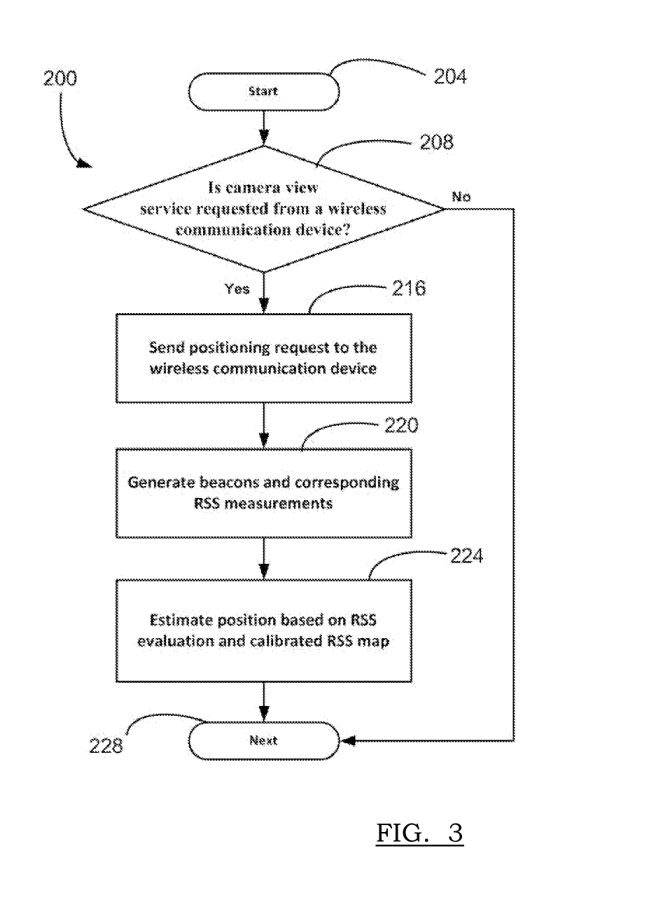

With reference to FIG. 3, a method of the WLAN positioning process is illustrated according to one or more embodiments and it is depicted by 200. After starts at step 204, the process 200 check on if camera view service request is received from a wireless communication device at step 208. When received, the process next sends from the camera control a positioning request to the wireless communication device at step 216. At step 220, RSS property is measured. If a network based WiFi positioning system topology is used, the wireless terminal device next sends positioning beacons to support RSS measurement at the network APs. If a terminal assisted WiFi positioning system topology is used, the wireless communication device next receive beacons from network APs and measure the received beacon RSS. Such measurement data is then packaged and sends to the positioning engine at step 224 to estimate the position of the wireless communication device in FCS 30 based on the RSS measurement and the calibrated RSSI map for the activity field. The process ends at step 228 and the estimated wireless communication device's position is regarded as the object position (xₒ, yₒ, zₒ) to support object targeting in camera view.

The camera with view control device 14 may contain different types of camera systems. Analog cameras and IP cameras are typically used. Depending on the camera system's orientation and zooming capability, the camera systems used are further classified to three categories: static camera, static zooming (SZ) camera and pan-tilt-zooming (PTZ) camera. A static camera has fixed orientation and focus after installation. In other words, the camera view and view region with respect to the activity field 38 is fixed. A SC camera has fixed orientation but automatically adjustable zooming ratio such that the area of the view region can be changed according to the zooming ratio selected. A PTZ camera can change both its orientation by adjusting its pan and tile angles and its view region by adjusting its zooming ratio. As a result, it provides flexibility to change the view region toward an area of interest with the best view centering capability in order to place the point of interest in the activity field at the center of the camera frames as close as possible.

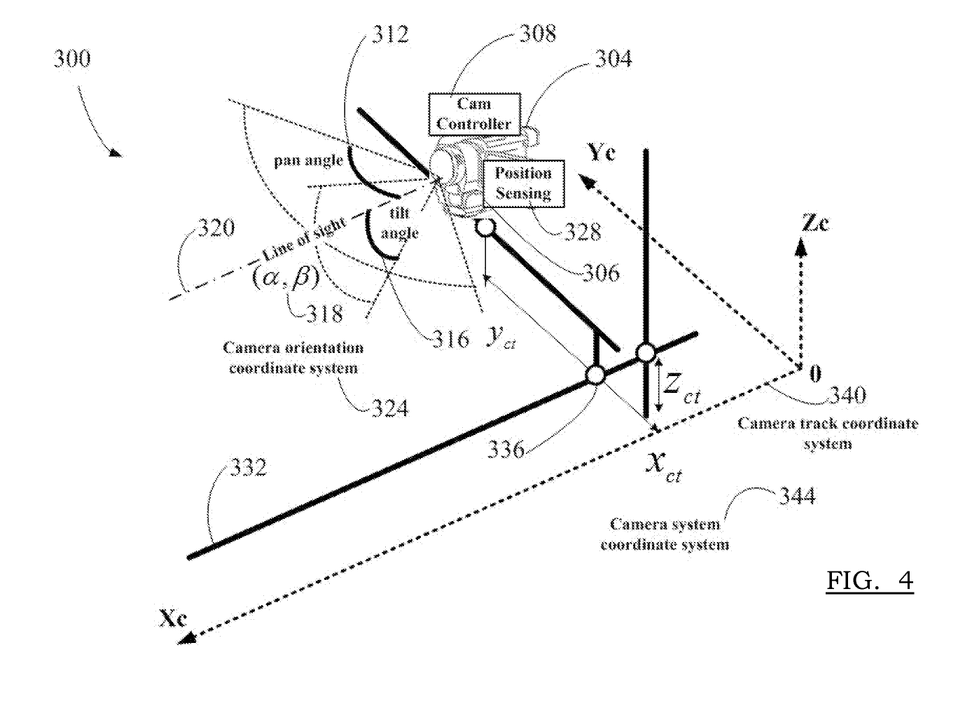

With reference to FIG. 4, a first embodiment of the PTZ camera is a physical PTZ camera and it is depicted by 300. A camera system comprises the following basic subsystems: a camera 304, a view control device that comprises a camera platform 306 with pan and tilt capability and a defined camera system coordinate system 344. Some camera system 300 further comprises a camera track system 332 and a camera track coordinate system 340.

The camera 304 is an optical instrument that records images and videos of camera views. The camera 304 has a line-of-sight 320 that determines the center of its view. The camera 304 has a camera platform 306 that can provide pan and tilt motion to adjust the orientation of the camera line-of-sight 320. The camera platform's pan angle 312 and tilt angle 316 determines its coordinates (α,β) 318 in a camera orientation coordinate system 324. The camera view control device also comprises a position sensing unit 328 to measure and report the present pan and tile angle of the camera platform 306. The position sensing unit 328 may further provide the pan and tilt motion measurements of the camera platform 306.

The camera view control device optionally comprises a camera track subsystem 332 that supports translational motion of the camera platform on the track through movable connections 336. Multiple movable connections 336 are illustrated in FIG. 3 by joint circles. Such connections provide longitudinal, lateral and vertical motions along the x_{c}, y_{c} and z_{c} axis of a camera track coordinate system 340. The coordinates of the camera platform 306 is (x_{ct}, y_{ct}, z_{ct}) in the camera track coordinate system. The camera orientation coordinate system 324 and the camera track coordinate system 340 together construct the camera system coordinate system 344. For camera systems 300 that do not have camera track subsystem 332, the camera system coordinate system 344 is the same as the camera orientation coordinate system 324.

The camera controller 308 is not only responsible to control the camera's basic functions and operations, but also in charge of controlling the camera orientation adjustment by operating the pan and tilt functions of the camera platform 306, and optionally adjusting the camera position on track 332. Furthermore, it is configured to perform at least one of orientation adjustment and object recognition for the view control device to target an object in camera view according to the determined position of the object in FCS 30.

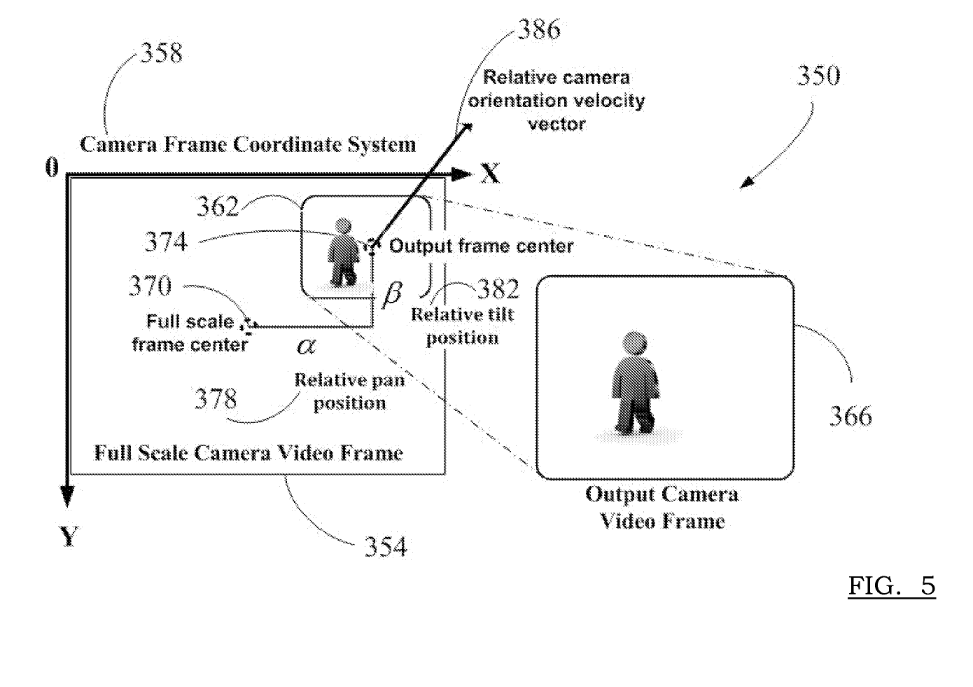

With reference to FIG. 5, an alternative embodiment of the PTZ camera is illustrated and depicted by 350. In this embodiment, the camera view control device is realized digitally with pan-tilt-zooming capabilities enabled by software features in camera controller. First, a high resolution full scale camera view video frame 354 is capture by the camera system. A camera frame coordinate system 358 is defined for the video frame 354 with X axis and Y axis perpendicular to each other. These axes define the horizontal and vertical position of image pixels.

The output camera view frame 366 delivered to service customers is only a subarea 362 of the original full scale camera video frame 354. The area of frame 366 vs. the area of frame 354 is determined by the digital zooming ratio of the digital PTZ function. The relative pixel position difference between the full scale frame center 370 and the output frame center 374 in the camera frame coordinate system determines the relative pan and tilt positions of the output frame 366 with respect to the full scale frame 354. In this case, the pan position 378 is defined by the horizontal distance α between center 370 and center 374. The tilt position 382 is defined by the vertical distance β between the centers. The digital pan motion is along the X-axis and the digital tilt motion is along the Y-axis in the camera frame coordinate system. In continuous video frame outputs, the relative motion of the output frame center 374 with respect to the full scale frame center 370 defines the orientation motion of the camera viewing system. Particularly, the relative orientation velocity vector [u_{α}, u_{β}] of the output frame with respect to the full scale video frame is depicted by the arrow 386. In a digital PTZ embodiment of the camera orientation control system, the camera frame coordinate system is also the camera system coordinate system.

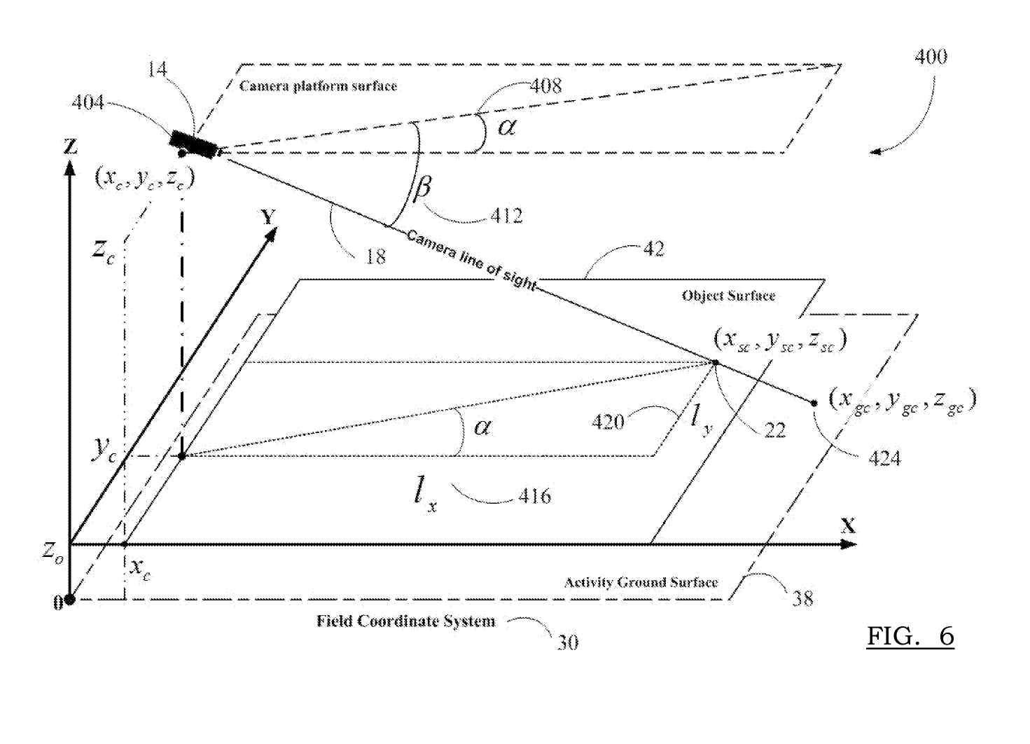

With reference to FIG. 6, a method for camera orientation adjustment is illustrated in accordance with one or more embodiments and is generally referenced by numeral 400. The camera orientation determines the direction of the camera line-of-sight 18 and subsequently determines the position of aim-point 22 in FCS 30. This method provides the fundamental coordinate transformation between FCS and the camera system coordinate system of a physical PTZ camera. The position coordinates (x_{c}, y_{c}, z_{c}) 404 of the camera 14 can be either obtained from installation or be derived from the coordinates of camera platform in camera track coordinate system. The following description about camera orientation adjustment is based on a known camera position in FCS. All the results can be easily extended to applications where a moving camera platform is used and (x_{c}, y_{c}, z_{c}) is time varying.

Based on the estimated height zₒ of the object position above the ground surface 38 from WLAN positioning, the height of the camera above the object surface 42 is: h_{c}=z_{c}−zₒ. And the height of the camera above the ground surface 38 is: h_{g}=z_{c}. The height of the object above the ground is: hₒ=zₒ. The z-axis value for the ground surface is usually assumed to be zero. A surface plane at the height zₒ is called the object surface 42 and a surface plane at the height of z_{c} is called camera platform surface. Both of the surfaces are parallel to the plane of activity ground.

According to the values of camera reported pan and tilt angles, the camera's heading angle α 408 and its overlook (look-down/look-up) angle β 412 can be derived. These two angles are usually linearly offset versions of the pan and tilt angles of the camera system. The horizontal distance between the camera and the object on the object surface can be computed as: lₓ=h_{c} cos α/tan β denoted by numeral 416 and l_{y}=h_{c} sin α/tan β denoted by numeral 420. The interception point of the camera line-of-sight 120 on the object surface 42 is the aim-point 22 at location (x_{sc}, y_{sc}, z_{sc}) where (x_{sc}, y_{sc}, z_{sc})=(x_{c}+lₓ, y_{c}+l_{y}, zₒ) in the field coordinate system 34. Similarly, the camera aim-point 424 evaluated on the ground surface is: (x_{gc}, y_{gc}, z_{gc})=(x_{c}+lₓ^{g}, y_{c}+l_{y}^{g}, 0), where l_{y}^{g}=h_{g} cos α/tan β and l_{y}^{g}=h_{g} sin α/tan β. Given the knowledge of (x_{c}, y_{c}, z_{c}), the camera orientation heading angle α and overlook angle β can be derived from a target aim-point (x_{sc}, Y_{sc}, z_{sc}) as:

$$( α , β ) = ( atan ( \frac{{y}_{sc} - {y}_{c}}{{x}_{sc} - {x}_{c}} ) , atan ( \frac{{h}_{c}}{\sqrt{{( {y}_{sc} - {y}_{c} )}^{2} + {( {x}_{sc} - xc )}^{2}}} ) ) \qquad ( 1 )$$

The camera orientation heading angular velocity ω_{α} and overlook angular velocity ω_{β} can be derived from a target aim-point velocity [u_{sc} v_{sc}] on the object surface as:

$$[ \begin{matrix}{ω}_{α} \\ {ω}_{β}\end{matrix} ] = \frac{1}{{h}_{c}} [ \begin{matrix}- sin ( α ) tan ( β ) & cos ( α ) tan ( β ) \\ - cos ( α ) {tan ( β )}^{2} {cos ( β )}^{2} & - sin ( α ) {tan ( β )}^{2} {cos ( β )}^{2}\end{matrix} ] [ \begin{matrix}{u}_{sc} \\ {v}_{sc}\end{matrix} ] \qquad ( 2 )$$

Equation (1) is used to determine the desired camera orientation (α,β) based on known camera aim-point position (x_{sc}, y_{sc}) on the object surface and Equation (2) is used to transform the aim-point velocity in FCS 30 to the desired pan-tilt speeds of the camera system in camera system coordinate system. When the object surface is not available, the ground surface is used instead.

After an object has been recognized in the camera frame, its position in the camera frame coordinate system can be used to determine the object's position in FCS 30. To this end, a coordination transformation method is needed for position conversation from the camera frame coordinate system to FCS. This process is called vision based positioning method. An exemplary embodiment of the vision positioning technique applies 3D projection method to establish coordinate mapping between the three-dimensional field coordinate system 30 to a two-dimensional camera video frame coordinate system 358. In the presentation of the proposed invention, perspective transform is used as exemplary embodiment of the 3D projection method. A perspective transform formula is defined to map coordinates between 2D quadrilaterals. Using this transform, a point in the first quadrilateral surface (P, Q) can be transformed to a location (M, N) on the second quadrilateral surface using the following formula:

$$M = \frac{aP + bQ + c}{gP + hQ + 1} \\ N = \frac{dP + eQ + f}{gP + hQ + 1} \qquad ( 3 )$$

And a velocity vector [u_{P}, u_{Q}] at point (P, Q) in the first quadrilateral surface can be transformed to a velocity vector [u_{M}, u_{N}] at point (M, N) on the second quadrilateral surface using the following formula:

$$\begin{matrix}{u}_{M} = \frac{[ ( ah - gb ) Q + ( a - gc ) ] {u}_{P} + [ ( bg - ah ) P + ( b - ch ) ] {u}_{Q}}{{( gP + hQ + 1 )}^{2}} & ( 4 ) \\ {u}_{N} = \frac{[ ( dh - ge ) Q + ( d - fg ) ] {u}_{P} + [ ( eg - dh ) P + ( e - fh ) ] {u}_{Q}}{{( gP + hQ + 1 )}^{2}} & ( 5 )\end{matrix}$$

Where a, b, c, d, e, f, g, h are constant parameters whose value are determined with respect to selected quadrilateral area and surface to be transformed between the two surfaces in different coordinate systems. After the positions of the characteristic points of a target object are identified in the camera video frame, equation (3) is used to locate their corresponding positions in the field coordinate system 30. In this case, the first quadrilateral is the image frame and the second quadrilateral is an area on a surface at a certain height zᵣ in the FCS 30. The object surface or the ground surface is typically used. When digital PTZ camera is used, equation (4) and (5) are used to transform the reference aim-point velocity [uᵣₐₚ, vᵣₐₚ] in the field coordinate system to the digital pan and tilt velocity [u_{α}, u_{β}] 386 in the camera frame coordinate system 358.

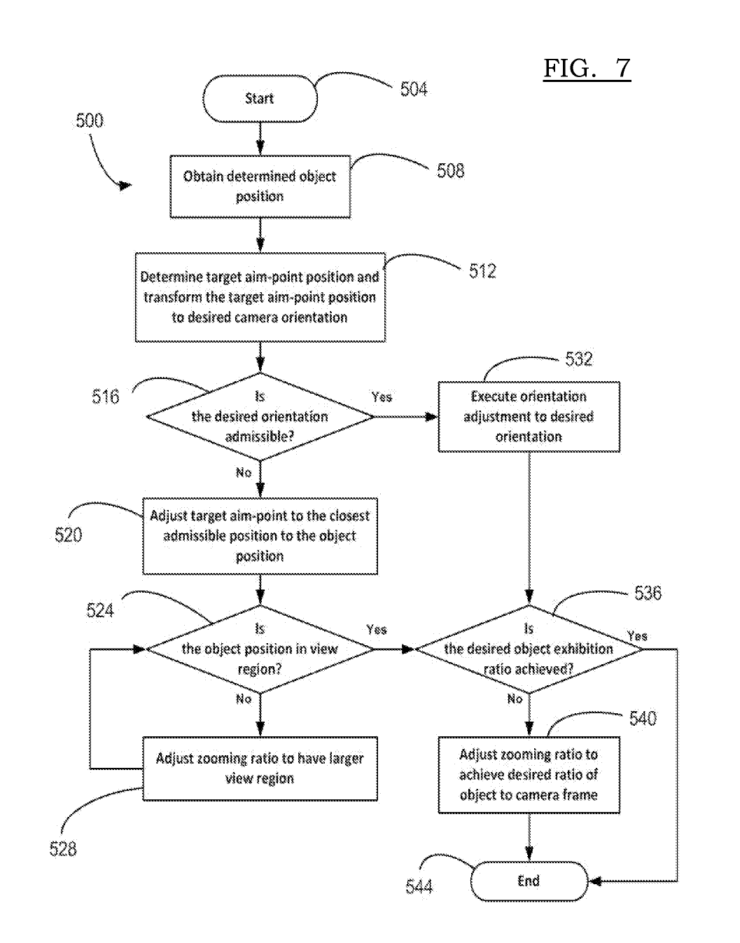

With reference to FIG. 7, a method of the camera orientation adjustment process for object targeting is illustrated in accordance with one or more embodiments and is generally referenced by numeral 500. The process starts at step 504 and it first obtained the determined object position from WLAN positioning engine at step 508. Based on the object position, a target aim-point position in FCS 30 is determined at step 512. A simple embodiment of the target aim-point position is to use the object position directly. The target aim-point position is transformed to a desired camera orientation in camera system coordinate system using Equation (1). The process 500 next checks on if the desired orientation is admissible based on orientation limitations at step 516. If the desired orientation is beyond orientation limits, the target aim-point is adjusted to the closest admissible position to the object position in FCS 30 at step 520. After that, it is checked whether the object position is covered by camera view region at step 524. The camera zooming ratio is then adjusted at step 528 to have a larger view region until the object position is sufficiently covered. The process 500 further verifies if the desired object exhibition ratio is achieved in camera view at step 536. If necessary, the camera zooming ratio is adjusted at step 540 to achieve desired relative size of the object presented in the camera view. At step 516, if determined that the target aim-point is admissible, the process 500 next operate camera view control device to reach the desired orientation at step 532. After that, the process goes to step 536 to check on object presentation sizing. The process ends at step 544.

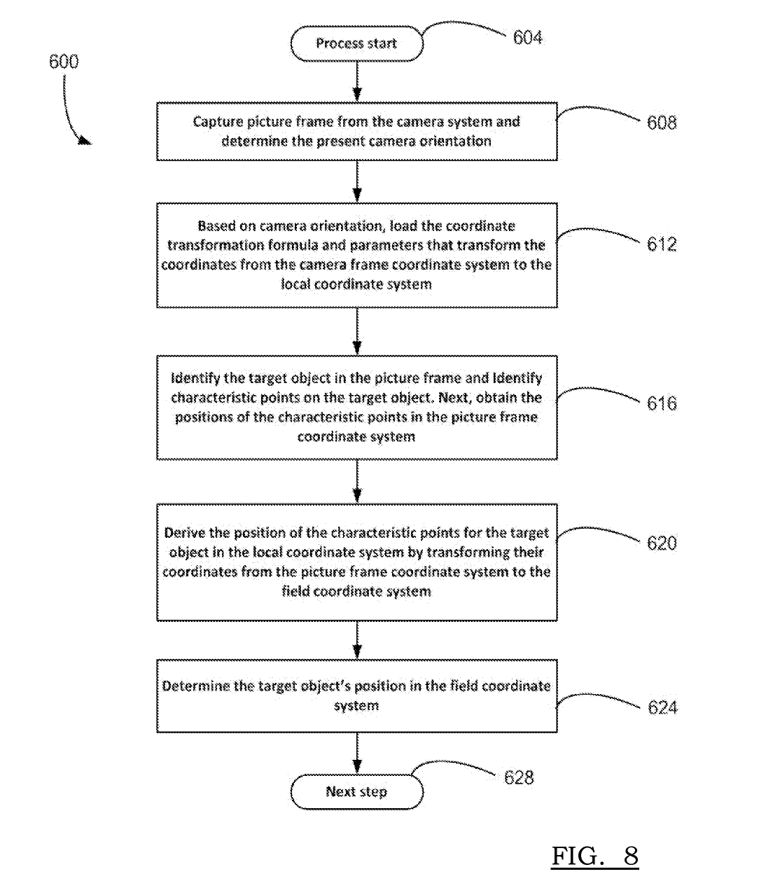

With reference to FIG. 8, a method of the vision positioning process to determine the location of an object captured in the camera picture frame is illustrated in accordance with one or more embodiments and is generally referenced by numeral 600. The process starts at step 604. While capturing a picture frame from the camera, the present camera orientation is obtained in the camera system coordinate system at step 608. Based on the camera system orientation data, predetermined and calibrated coordinate transformation formula, like the perspective transform equation (3), and its parameters are loaded from a database at step 612. 3D projection transformation methods are used for such transformation formula to convert positions between the camera frame coordinate system and the field coordinate system. Perspective transform and estimation method is an exemplary embodiment of the 3D projection transformation methods for the transformation formulation and parameter identifications. Next, the target object is identified in the picture frame with object characteristic points identified on the target object. A simplest method is to use the position of the target center point to represent the position of the target object. For target object that comprises multiple individual objects, each of the objects is used as an object characteristic point and the position of the target object can be derived from the positions of these objects using their mass center, geometric center, boundary points, etc. The positions of the object characteristic points are obtained in the camera frame coordinate at step 616. The positions of the object characteristic points in the field coordinate system are then derived at step 620 using the coordinate transformation formula and parameters at loaded step 612. The object position in the field coordinate system is then determined at step 624. This object position is call object characteristic position (\hat{x}ₒ, ŷₒ, \hat{z}ₒ). After that, the process ends at step 628 with other operations.

When both a WiFi based positioning result and a vision based positioning result are available, they are jointed together through a position fusion algorithm. Let C_{w} and Cᵥ denote the object location estimated from the WiFi positioning technique and the vision based positioning technique, respectively. Their associated noise variances are σ_{w}² and σᵥ². By applying the Central Limit Theorem, the combined object location estimation C_{wv} is obtained as:

C_{wv}=σ_{c}²(σ_{w}⁻²C_{w}+σᵥ⁻²Cᵥ) (6)

where σ_{wv}²=(σ_{w}²+σᵥ²)⁻¹ is the variance of the combined estimate. It can be seen that the fused result is simply a linear combination of the two measurements weighted by their respective noise variances. Alternatively, Kalman filter can be used to fuse together the WiFi and Vision position estimations by applying a first-order system. Particle filters and Hiden Markov Model can also be used to improve the positioning accuracy. The Hiden Markov Model is a statistical model allows the system to integrate the likelihood of a movement or positional change. The fusion of the target object positioning results generates a higher accurate and reliable target object position ( x̅ₒ, y̅ₒ, z̅ₒ).

A vision base object positioning result is available until candidate objects have been determined. Before that, the camera view control relies solely on the WLAN positioning result to initialize the object finding and targeting process. The vision positioning result for candidate objects can help identifying the final object of interest by comparing the consistency and correlation between the WLAN object position (xₒ, yₒ, zₒ) and the vision object position (\hat{x}ₒ, ŷₒ, \hat{z}ₒ). For the finalized target object, the vision based object position can help improving the camera orientation adjustment precision to achieve better targeting and exhibition of the object in camera view.

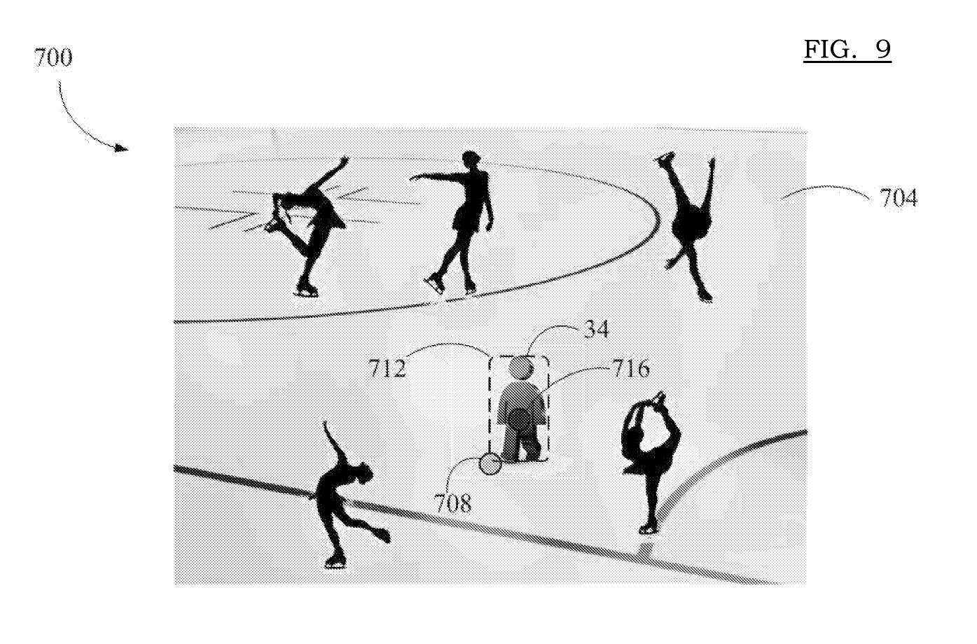

When a camera's orientation adjustment is not available or is limited, centering an object in the camera frame becomes difficult. In these situations, object recognition is used for object targeting in order to support object initialization and specification. With reference to FIG. 9, an exemplary embodiment of object recognition method is illustrated and depicted by 700. Picture frame 704 is an exemplary camera view over an activity field in an ice rink. Multiple players are presented in the present camera view region. When an object's position in FCS 30 is determined, the position is transformed into a position in the camera frame coordinate system 358, or called pixel coordinate system. This new position is denoted by dot 708. The object recognition method start identify target object 34 at or near the position at dot 708 using image processing and machine vision techniques. Once recognized, the target object is then profiled using certain object characterization methods. For example, a rectangle envelop 712 is used in FIG. 9 to illustrate an embodiment of object profiling method that highlights the target object in camera view frames. Furthermore, characteristic object points 716 are also identified with certain relationship to the object. An exemplary embodiment of the characteristic object points is the object center point 716. The positions of characteristic object points can be obtained in the camera frame coordinate system and then transformed to corresponding positions in FCS 30. These transformed positions of the characteristic object points are called characteristic objected position and they are used to refine the determine object position in FCS 30 in order to compensate the positioning inaccuracy involved in the WLAN positioning process.

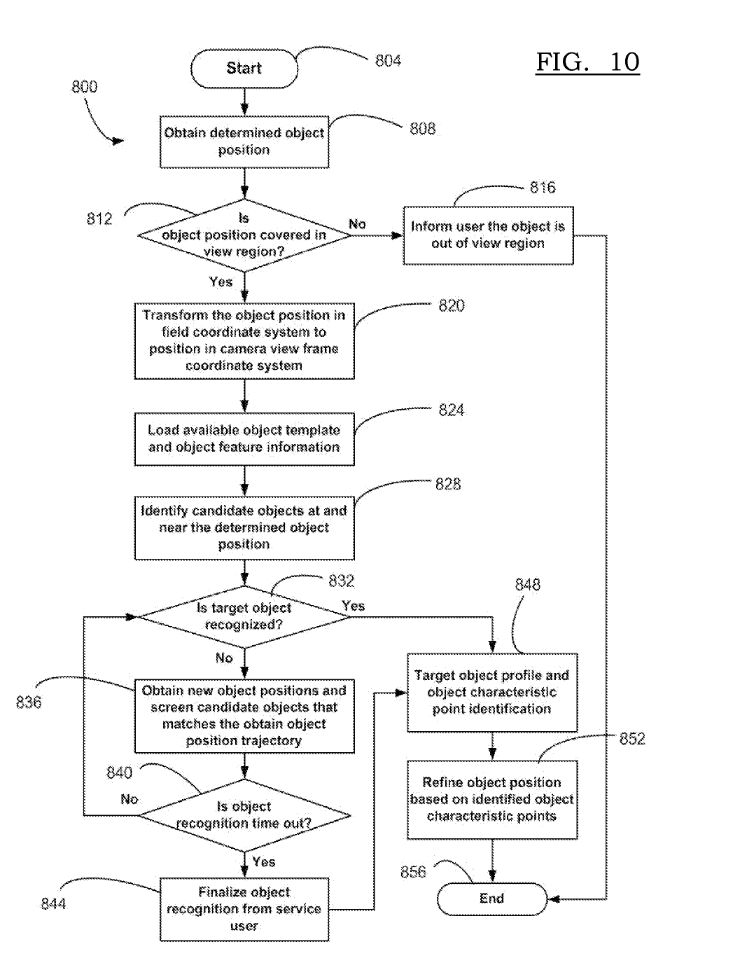

With reference to FIG. 10, a method for object recognition process is illustrated in accordance with one or more embodiments and is generally referenced by numeral 800. After the process starts at 804, the determined object position is first obtained from the WLAN positioning engine 62 at step 808. If determined that the determined position is outside the camera view region at step 812, the process next information service user at 816 and the preset object recognition process 800 stops at step 856. Otherwise, the determined object position in view region is transformed through projection conversion from coordinates in the FCS 30 to coordinates 708 in the camera frame coordinate system. Next, available object information is loaded by the object recognition algorithm at step 824. Such object information can be object templates or object features that are predetermined to characterize object of interest in certain application situations. Such object information can largely help improving the object recognition fastness and accuracy. Based on the object position and WLAN positioning error range, candidate objects at or near the object position are all identified at step 828. The process 800 next check if a target object has been recognized at step 832. If multiple candidate objects exist, the process 800 continues to step 836. While new object position data are requested and obtain, the method screens the candidate objects by comparing their moving trajectory to the projected position trajectory transformed from the object's position variations in the camera frame to the reported object position trajectory in FCS 30. The candidate objects whose motions do not match the obtained object trajectory are removed and a final target object is specified. When such object finalization process cannot be finished within certain time duration at 840, certain user assistance may be request at step 844 to help confirming the target object among the rest candidate objects. The process 800 next goes to step 848 after the target object has been specified in the camera view. The target object is then profiled with methods to differentiate it from surrounding objects. Furthermore, characteristic object points 116 are identified for the recognized target object. Object center point or foot point are typical characteristic object points used. By converting the coordinates of the characteristic object points back to the FCS 30, the position of the object in FCS 30 can be refined at step 852 since the camera based positioning method usually has higher position precision than the WLAN positioning system. Such a refined characteristic object position can help achieving better object targeting especially when PTZ camera are used to place the target object at the predefined frame position accurately. The object recognition process 800 stops at step 856.

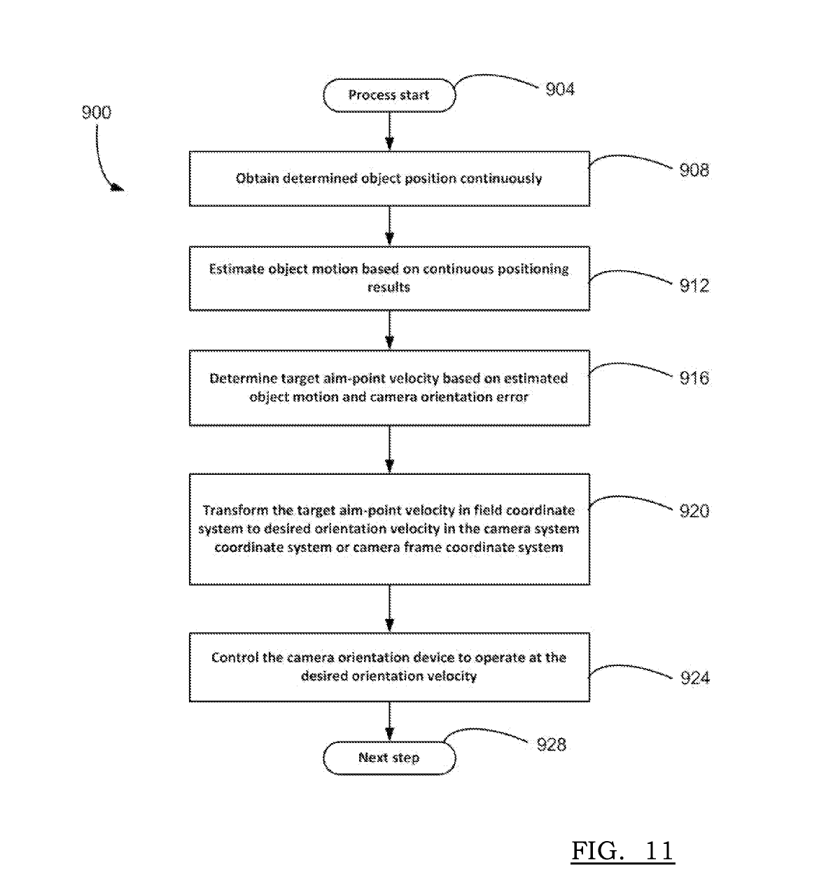

After object initialization, when target object has been found but it has not been confirmed, the camera view control needs to operate the camera view control device in a motion to follow the target object's motion in order to keep the target object continuously in camera view while it is moving. With reference to FIG. 11, a method for targeting moving object is illustrated in accordance with one or more embodiments and is generally referenced by numeral 900. After the process starts at 904, the method obtains the determined object positioning result continuously in a short time interval at step 908. In this method, the determined object position result can use any one of the WLAN positioning result (xₒ, yₒ, zₒ), the vision positioning result (\hat{x}_{w}, ŷₒ, \hat{z}ₒ) and the fused object position ( x̅ₒ, y̅ₒ, z̅ₒ). Using (xₒ, yₒ, zₒ) as example, the position obtained most recently is denoted by (xₒ (t), yₒ(t), zₒ(t)) and the position obtained in the last time interval is denoted by (xₒ(t−Δt), yₒ(t−Δt), zₒ(t−Δt)), where Δt is the time interval. The object motion velocity can thus be estimated at step 912 as:

$${u}_{o} = \frac{{x}_{o} ( t ) - {x}_{o} ( t - Δ t )}{Δ t}$$

$${v}_{o} = \frac{{y}_{o} ( t ) - {y}_{o} ( t - Δ t )}{Δ t}$$

where by assuming zₒ(t)=zₒ(t−Δt), the presented embodiment of the method is used for object in planar motion. This assumption is only used to simplify the presentation. It shall not be used as limiting the scope of the application. The object velocity [uₒ, vₒ] computed from numerical derivative is usually filtered using a low pass filter to smooth the result from noise signal. Alternatively, a Kalman filter or particle filter can be used for object velocity estimation.

At the next step 916, the target aim-point velocity needs to be derived in order for the camera view to cover the object continuously in motion. To this end, the position error is first evaluated as:

eₓ=xₒ−x_{sc},e_{y}=yₒ−y_{sc}

The target aim-point motion aims at follow the object motion while minimizing the position error between the aim-point position and the object position. An exemplary embodiment of the target aim-point velocity is determined as:

$$[ \begin{matrix}{u}_{sc} \\ {v}_{sc}\end{matrix} ] = [ \begin{matrix}{k}_{up} {e}_{x} + {k}_{ui} {\int }_{0}^{t} {e}_{x} d t + {u}_{o} \\ {k}_{vp} {e}_{y} + {k}_{vi} {\int }_{0}^{t} {e}_{y} d t + {v}_{o}\end{matrix} ] \qquad ( 7 )$$

The target aim-point velocity in Equation (7) has to be transformed into corresponding camera coordinate system to be implemented for orientation adjustment. This is done at step 920, if a physical PTZ camera is used, Equation (2) is used to derive the desired camera orientation motion in pan and tilt angular speeds. If a digital PTZ camera is used, Equation (4) and (5) are used to transform the aim-point motion in FCS 30 to the camera frame coordinate system 358. Next, the derived camera orientation velocity is commended to the camera view control device at step 924 to operate at the desired orientation velocity such that the camera view achieves the same motion as a moving object in the FCS 30. This method ends at step 928 and the camera view controller continues with other control functions.

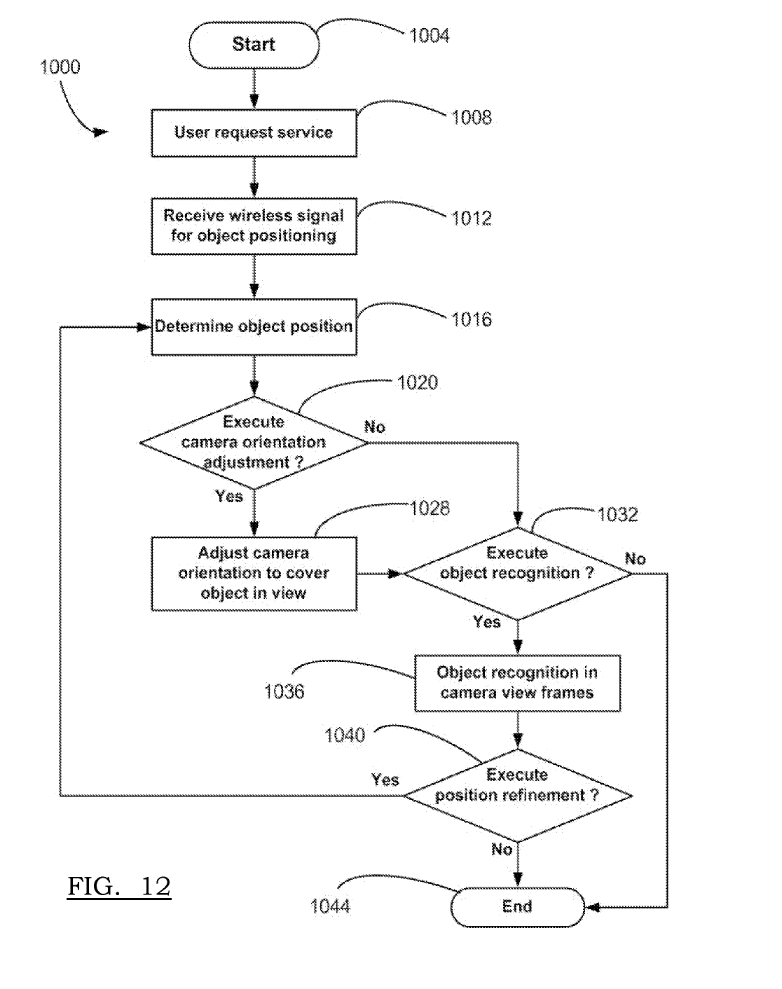

Now, the overall camera view control system and method can be summarized. With reference to FIG. 12, a camera orientation adjustment method for automatically targeting object in camera view is illustrated in accordance with one or more embodiments and is generally referenced by numeral 1000. After start at step 1004, the method first receives service request from user at step 1008. Radio wave signals from wireless communication devices is then received and these signals as well as their reception properties like signal strength indicator, angle of arrival, time of arrival and time difference of arrival are used for object positioning at step 1012. The position of an object is initially determined based on the positioning result from its associated wireless communication result obtained from WLAN positioning engine at 1016. The method 200 is used. When a higher precision positioning result for the object is obtained from vision based positioning methods, step 1016 also arbitrate the different sources of positioning results and generate a final highly accurate object position in FCS 30. The method 1000 next checks on if camera adjustment execution is allowed at step 1020. If allowed, the camera view control device adjusts the camera orientation such that the camera view covers and targets the object at step 1028. The method 500 and method 900 are used in this step. If the camera orientation adjustment is done or when it is not allowed, the method 1000 checks if object recognition execution is allowed. If not, the method stops at step 1044. Otherwise, the object recognition method 800 is used to recognize object in camera view frames and to obtain the position of the recognized object in the camera frame coordinate system at step 1036. The method 600 is used to transform the object position in the camera frame coordinate system to the field coordinate system 30. Next, the method 1000 checks on if object position refinement is needed at step 1040. The object position refinement improves the object positioning precision by supplying vision based object positioning result such that the camera orientation can be better postured to cover and exhibit the object in camera view in an optimal manner. If needed, the method 1000 switches back to object position determination at step 1016 and the subsequent procedures are repeated until satisfied object positioning and camera view targeting results are achieved. After that, the method 1000 ends at step 1044.

As demonstrated by the embodiments described above, the methods and apparatus of the present invention provide advantages over the prior art by enabling automatic object initialization and targeting in activity field before a target object has been specified.

While the best mode has been described in detail, those familiar with the art will recognize various alternative designs and embodiments within the scope of the following claims. Additionally, the features of various implementing embodiments may be combined to form further embodiments of the invention. While various embodiments may have been described as providing advantages or being preferred over other embodiments or prior art implementations with respect to one or more desired characteristics, those of ordinary skill in the art will recognize that one or more features or characteristics may be compromised to achieve desired system attributes, which depend on the specific application and implementation. These attributes may include, but are not limited to: cost, strength, durability, life cycle cost, marketability, appearance, packaging, size, serviceability, weight, manufacturability, ease of assembly, etc. The embodiments described herein that are described as less desirable than other embodiments or prior art implementations with respect to one or more characteristics are not outside the scope of the disclosure and may be desirable for particular applications. Additionally, the features of various implementing embodiments may be combined to form further embodiments of the invention.

What is claimed is:

1. A camera comprising:
a view control device configured for automatic object targeting; and
a controller configured to
receive radio wave signals from wireless communication devices in a wireless local area network and determine the position of an object in a field coordinate system based on said radio wave signals from said wireless communication device associated to said object; and
perform at least one of orientation adjustment and object recognition for said view control device to target said object in camera view according to the determined position of said object in said field coordinate system.

2. The camera of claim 1, wherein the determined object position is based on at least one of pattern recognition method, triangulation method and trilateration method using at least one of the received signal strength, the angle of arrival, the time of arrival and the time difference of arrival of said radio wave signals.

3. The camera of claim 1, wherein said field coordinate system is defined over an activity filed such that each position has a unique coordinate identity.

4. The camera of claim 1, wherein the view control device comprises at least one of physical orientation adjustment device, digital orientation adjustment device and object recognition software programs to target an object in camera view.

5. The camera of claim 1, wherein the controller is further configured to perform orientation adjustment including at least one of:
(i) adjust the orientation of the view control device to cover the determined object position in camera view;
(ii) determine a target aim-point position in said field coordinate system based on the determined object position; and adjust the orientation of the view control device to place the camera aim-point at said target aim-point position;
(iii) determine a camera zooming ratio to cover and to exhibit said object sufficiently in camera view.

6. The camera of claim 1, wherein the controller is further configured to perform object recognition including at least one of:
(i) recognize said object at or near the determined object position in camera view;
(ii) recognize said object based on matching trajectory of determined object position;
(ii) identify characteristic position of said object in said field coordinate system; and
(iii) outline recognized object in camera view frames to distinguish it from surrounding objects and background.

7. The camera of claim 1, wherein the controller is further configured to perform orientation adjustment including at least one of:
(i) estimate object motion in said field coordinate system based on at least one of the determined object position and the identified object characteristic position;
(ii) determine a target aim-point motion in said field coordinate system based on at least one of the estimated object motion and the position error between the determined object position and the camera aim-point; and control the view control device to realize target aim-point motion.

8. A method comprising:
receive radio wave signals from wireless communication devices in a wireless local area network and determine the position of an object in a field coordinate system based on said radio wave signals from said wireless communication device associated to said object; and
perform at least one of orientation adjustment and object recognition for said view control device to target said object in camera view according to the determined position of said object in said field coordinate system.

9. The method of claim 8, wherein the determined object position is based on at least one of pattern recognition method, triangulation method and trilateration method using at least one of received signal strength, angle of arrival, time of arrival and time difference of arrival of said radio wave signals.

10. The method of claim 8, wherein the view control device comprises at least one of physical orientation adjustment device, digital orientation adjustment device and object recognition software programs to target an object in camera view.

11. The method of claim 8, wherein the controller is further configured to perform orientation adjustment including at least one of:
(i) adjust the orientation of the view control device to cover the determined object position in camera view;
(ii) determine a target aim-point position in said field coordinate system based on the determined object position; and adjust the orientation of the view control device to place the camera aim-point at said target aim-point position;
(iii) determine a camera zooming ratio to cover and to exhibit said object sufficiently in camera view.

12. The method of claim 8, wherein the controller is further configured to perform object recognition including at least one of:
(i) recognize said object at or near the determined object position in camera view;
(ii) recognize said object based on matching trajectory of determined object position;
(ii) identify characteristic position of said object in said field coordinate system; and
(iii) outline recognized object in camera view frames to distinguish it from surrounding objects and background.

13. The method of claim 8, wherein the controller is further configured to perform orientation adjustment including at least one of:
(i) estimate object motion in said field coordinate system based on at least one of the determined object position and the identified object characteristic position;
(ii) determine a target aim-point motion in said field coordinate system based on at least one of the estimated object motion and the position error between the determined object position and the camera aim-point; and control the view control device to realize target aim-point motion.

14. A view control system comprising:
at least one controller configured to
receive radio wave signals from wireless communication devices in a wireless local area network and determine the position of an object in a field coordinate system based on said radio wave signals from said wireless communication device associated to said object; and
perform at least one of orientation adjustment and object recognition for said view control device to target said object in camera view according to the determined position of said object in said field coordinate system.

15. The view control system of claim 14, wherein the determined object position is based on at least one of pattern recognition method, triangulation method and trilateration method using at least one of received signal strength, angle of arrival, time of arrival and time difference of arrival of said radio wave signals.

16. The view control system of claim 14, wherein the determined object position has coordinates defined in said field coordinate system such that each position has a unique coordinate identity.

17. The view control system of claim 14, wherein the view control device comprises at least one of physical orientation adjustment device, digital orientation adjustment device and object recognition software programs to target an object in camera view.

18. The view control system of claim 14, wherein the controller is further configured to perform orientation adjustment including at least one of:
(i) adjust the orientation of the view control device to cover the determined object position in camera view;
(ii) determine a target aim-point position in said field coordinate system based on the determined object position; and adjust the orientation of the view control device to place the camera aim-point at said target aim-point position;
(iii) determine a camera zooming ratio to cover and to exhibit said object sufficiently in camera view.

19. The view control system of claim 14, wherein the controller is further configured to perform object recognition including at least one of:
(i) recognize said object at or near the determined object position in camera view;
(ii) recognize said object based on matching trajectory of determined object position;
(ii) identify characteristic position of said object in said field coordinate system; and
(iii) outline recognized object in camera view frames to distinguish it from surrounding objects and background.

20. The view control system of claim 14, wherein the controller is further configured to perform orientation adjustment including at least one of:
(i) estimate object motion in said field coordinate system based on at least one of the determined object position and the identified object characteristic position;
(ii) determine a target aim-point motion in said field coordinate system based on at least one of the estimated object motion and the position error between the determined object position and the camera aim-point; and control the view control device to realize target aim-point motion.
